(19) United States
(12) Patent Application Publication
(10) Pub. No.: US 2014/0050465 A1
(43) Pub. Date: Feb. 20, 2014

(54) HEAT MEDIUM HEATING DEVICE AND VEHICULAR AIR-CONDITIONING DEVICE INCLUDING THE SAME

(71) Applicants: Satoshi Kominami, Tokyo (JP); Naoto Kunieda, Aichi (JP)

(72) Inventors: Satoshi Kominami, Tokyo (JP); Naoto Kunieda, Aichi (JP)

(73) Assignee: MITSUBISHI HEAVY INDUSTRIES AUTOMOTIVE THERMAL SYSTEMS CO., LTD., Kiyosu-shi ,Aichi (JP)

(21) Appl. No.: 14/113,516

(22) PCT Filed: Aug. 31, 2012
(86) PCT No.: PCT/JP2012/072261

§ 371 Date: Oct. 23, 2013

(30) Foreign Application Priority Data
Sep. 28, 2011 (JP) 2011-212614

(51) Int. Cl. B60H 1/22; F24H 3/02

(52) U.S. Cl. CPC B60H 1/2225; F24H 3/022
USPC 392/482

(57) ABSTRACT

Provided are: a heat medium heating device capable of bringing: flat heat exchange tubes and PTC heaters; and inlet/outlet header parts of the flat heat exchange tubes, into sufficiently close contact with each other, and incorporating these components into a casing; and a vehicular air-conditioning device including the same. In a heat medium heating device, flat heat exchange tubes each including a flat tube part and inlet/outlet header parts and PTC heaters are stacked in layers, and a heat exchange holding member presses the flat heat exchange tubes from one side, whereby the stacked structure is incorporated on an inner bottom surface of a casing. In this configuration, at least uppermost one of the flat heat exchange tubes has one surface pressed by the heat exchange holding member, the one surface being formed into a planar shape in which the flat tube part and the inlet/outlet header parts are flattened.

### TECHNICAL FIELD

The present invention relates to a heat medium heating device that heats a heat medium using a PTC heater and a vehicular air-conditioning device including the heat medium heating device.

### BACKGROUND ART

In vehicular air-conditioning devices applied to electric automobiles, hybrid automobiles, and the like, it is known to use a positive temperature coefficient (PTC) heater for a heat medium heating device that heats a heat medium to be heated serving as a heat source for air heating. The PTC heater includes a positive temperature thermistor (hereinafter referred to as PTC element) as its heating element. With regard to such a heat medium heating device, PTL 1 discloses that: a housing includes an inlet and an outlet of a heat medium; a large number of partition walls for dividing the inside of the housing into a heating chamber and a circulation chamber of the heat medium are provided; a PTC heating element is inserted and placed in the heating chamber sectioned by the partition walls so as to be in contact with the partition walls; and the heat medium circulating in the circulation chamber is heated by the PTC heating element with the intermediation of the partition walls.

PTL 2 discloses a heat medium heating device having a stacking structure in which: a tabular PTC heater is configured by providing an electrode plate, an electrically insulating layer, and a heat transfer layer on each surface of a PTC element; a pair of heat medium circulation boxes that include an inlet and an outlet of a heat medium and are communicated with each other are respectively stacked on both surfaces of the PTC heater; and a substrate housing box and a cover for housing a control substrate are further provided on the outer side of the resultant structure.

Unfortunately, in the heat medium heating device disclosed in PTL 1, it is difficult to closely insert and place the PTC heating element to between the partition walls serving as heat transfer surfaces, and the thermal contact resistance between the partition walls and the PTC heating element increases, resulting in a decrease in heat transfer efficiency. Further, in the heat medium heating device disclosed in PTL 2, close contact between the PTC heater and the heat medium circulation boxes can be enhanced, and the thermal contact resistance can be reduced. Meanwhile, because it is difficult to arrange PTC heaters in a plurality of layers, the planar area increases, and the heat medium circulation boxes and the special substrate housing box are necessary, which put a limitation on a reduction in size, weight, and cost.

A heat medium heating device that has been developed in view of the above has a configuration in which: heat exchange tubes having a flat structure are used; the flat heat exchange tubes and PTC heaters are stacked in a plurality of layers; and the stacked structure is pressed to be incorporated into a casing. As disclosed in PTL 3, tubes are frequently used for a heat exchange element having a configuration in which a plurality of flat heat exchange tubes are stacked, the tubes being each formed by attaching a pair of molded plate members including a refrigerant inlet header part, a refrigerant outlet header part, and a flat tube part that are integrally formed by press molding. It is known that an inner fin is provided in the flat tube part, that the inlet header part and the outlet header part are provided next to each other at one end of the flat tube part, and that the inlet header part and the outlet header part are separately provided at both ends thereof. An outer fin, a cooling target, a heat source, and the like are stacked and disposed between the plurality of flat heat exchange tubes.

### CITATION LIST

### Patent Literature

### {PTL 1}

Japanese Unexamined Patent Application, Publication No. 2008-7106

### {PTL 2}

Japanese Unexamined Patent Application, Publication No. 2008-56044

### {PTL 3}

Japanese Unexamined Patent Application, Publication No. 2007-322020

### SUMMARY OF INVENTION

### Technical Problem

In the case of such flat heat exchange tubes each including a flat tube part, an inlet header part, and an outlet header part that are integrally molded, in general, the header thickness of the inlet header part and the outlet header part is larger than the tube thickness of the flat tube part. In order to bring: the respective flat tube parts of the flat heat exchange tubes and PTC heaters stacked in a plurality of layers; the respective inlet header parts of the flat heat exchange tubes; and the respective outlet header parts of the flat heat exchange tubes, into close contact with each other, it is necessary to simultaneously press a plurality of planar regions, that is, the flat tube parts, the inlet header parts, and the outlet header parts. Unfortunately, because each component has a dimensional tolerance, an assembling tolerance, and the like, it is difficult to simultaneously and uniformly press the plurality of planar regions, so that it is not always possible to simultaneously secure close contact between the flat tube parts and the PTC heaters, between the inlet header parts, and between the outlet header parts.

If the close contact between the flat tube parts and the PTC heaters is not secured, the thermal contact resistance therebetween increases, resulting in a decrease in heat transfer efficiency. If the inlet header parts or the outlet header parts are not brought into sufficiently close contact with each other, it is difficult to secure sealing properties of an O-ring or the like that seals a portion around a communication hole provided to each of the inlet header parts and the outlet header parts, causing a risk that a heat medium may leak. For this reason, there is no choice but to prioritize the securement of the sealing properties around the communication holes, and hence the close contact between the flat tube parts and the PTC heaters may not always be sufficiently secured.

The present invention, which has been made in view of the above-mentioned circumstances, has an object to provide: a heat medium heating device capable of bringing: respective flat tube parts of a plurality of flat heat exchange tubes and PTC heaters; respective inlet header parts of the flat heat exchange tubes; and respective outlet header parts of the flat heat exchange tubes, into sufficiently close contact with each other, and incorporating these components into a casing in such a close contact state; and a vehicular air-conditioning device including the heat medium heating device.

### Solution to Problem

In order to solve the above-mentioned problem, a heat medium heating device and a vehicular air-conditioning device including the same according to the present invention adopt the following solutions.

That is, a heat medium heating device according to a first aspect of the present invention includes: a plurality of flat heat exchange tubes each including: an inlet header part from which a heat medium flows into the flat heat exchange tube; a flat tube part in which the heat medium circulates; and an outlet header part from which the heat medium flows out of the flat heat exchange tube; PTC heaters that are respectively incorporated to between the flat tube parts of the plurality of flat heat exchange tubes; a casing in which the flat heat exchange tubes and the PTC heaters are alternately stacked and incorporated in a plurality of layers; and a heat exchange holding member that presses the flat heat exchange tubes stacked in the plurality of layers from one side thereof, to thereby tighten and fix the flat heat exchange tubes to an inner bottom surface of the casing. At least an uppermost flat heat exchange tube of the plurality of stacked flat heat exchange tubes has one surface pressed by the heat exchange holding member, the one surface being formed into a planar shape in which the inlet header part, the outlet header part, and the flat tube part are flattened.

According to the first aspect, the flat heat exchange tubes and the PTC heaters are alternately stacked in the plurality of layers, and the heat exchange holding member presses the flat heat exchange tubes from one side thereof, whereby the flat heat exchange tubes and the PTC heaters are tightened and fixed to the inner bottom surface of the casing. In the heat medium heating device thus configured, at least the uppermost flat heat exchange tube of the plurality of stacked flat heat exchange tubes has the one surface pressed by the heat exchange holding member, the one surface being formed into the planar shape in which the inlet header part, the outlet header part, and the flat tube part are flattened. Accordingly, one surface of the heat exchange holding member is brought into contact with the one surface flattened into such a planar shape, of the uppermost one of the flat heat exchange tubes stacked in the plurality of layers, and substantially the entire surface of the uppermost flat heat exchange tube is substantially uniformly pressed, whereby the flat heat exchange tubes and the PTC heaters can be tightened and fixed to the inner bottom surface of the casing. Accordingly, it is possible to enhance close contact between the respective inlet header parts of the plurality of flat heat exchange tubes, between the respective outlet header parts of the flat heat exchange tubes, and between the respective flat tube parts of the flat heat exchange tubes and the PTC heaters, and thus secure sealing properties around each of communication holes of the inlet header parts and the outlet header parts. It is also possible to reduce the thermal contact resistance between the flat heat exchange tubes and the PTC heaters to improve the heat transfer efficiency, and achieve a reduction in size and an increase in performance of the heat medium heating device. Further, because the one surface of the uppermost flat heat exchange tube is flattened, the size (thickness) in the stacking direction of the plurality of stacked flat heat exchange tubes can be reduced, and the heat medium heating device can be compactified accordingly.

Moreover, in the heat medium heating device according to the first aspect, a lowermost flat heat exchange tube of the flat heat exchange tubes stacked in the plurality of layers may have one surface in contact with the inner bottom surface of the casing, the one surface being formed into a planar shape in which the inlet header part, the outlet header part, and the flat tube part are flattened.

According to the first aspect, the lowermost flat heat exchange tube of the flat heat exchange tubes stacked in the plurality of layers has the one surface in contact with the inner bottom surface of the casing, the one surface being formed into the planar shape in which the inlet header part, the outlet header part, and the flat tube part are flattened. Accordingly, when the heat exchange holding member presses the one surface of the uppermost flat heat exchange tube, to thereby tighten and fix the flat heat exchange tubes and the PTC heaters stacked in the plurality of layers to the inner bottom surface of the casing, the flattened surface of the lowermost flat heat exchange tube is brought into contact with the inner bottom surface of the casing, and the pressing force of the heat exchange holding member can be substantially uniformly received by substantially the entire flattened surface of the lowermost flat heat exchange tube. Also with this configuration, it is possible to enhance close contact between the respective inlet header parts of the plurality of flat heat exchange tubes, between the respective outlet header parts of the flat heat exchange tubes, and between the respective flat tube parts of the flat heat exchange tubes and the PTC heaters, and thus secure sealing properties around each of the communication holes of the inlet header parts and the outlet header parts. It is also possible to reduce the thermal contact resistance between the flat heat exchange tubes and the PTC heaters to improve the heat transfer efficiency, and achieve a reduction in size and an increase in performance of the heat medium heating device. Further, because the one surface of the lowermost flat heat exchange tube is flattened, the size (thickness) in the stacking direction of the plurality of stacked flat heat exchange tubes can be reduced, and the heat medium heating device can be compactified accordingly.

Moreover, in the heat medium heating device according to the first aspect, the plurality of flat heat exchange tubes may be each formed by attaching a pair of molded plate members including the inlet header part, the outlet header part, and the flat tube part that are integrally formed by press molding, and the inlet header part, the outlet header part, and the flat tube part that are molded in one of the molded plate members constituting the uppermost flat heat exchange tube and/or the lowermost flat heat exchange tube may be flattened into a planar shape.

According to the first aspect, the plurality of flat heat exchange tubes are each formed by attaching the pair of molded plate members including the inlet header part, the outlet header part, and the flat tube part that are integrally formed by press molding. The inlet header part, the outlet header part, and the flat tube part that are molded in one of the molded plate members constituting the uppermost flat heat exchange tube and/or the lowermost flat heat exchange tube are flattened into the planar shape. Hence, if one of the pair of molded plate members constituting the uppermost flat heat exchange tube and/or the lowermost flat heat exchange tube is changed, that is, if the inlet header part and the outlet header part that are molded in the one of the molded plate members are configured to have the same planar height as that of the flat tube part, the uppermost flat heat exchange tube and/or the lowermost flat heat exchange tube including the flattened inlet header part, outlet header part, and flat tube part can be manufactured. Accordingly, although two types of flat heat exchange tube need to be manufactured and manufacturing costs for the tubes thus increase, the size in the stacking direction of the flat heat exchange tubes can be reduced, and a reduction in size and an increase in performance of the heat medium heating device can be achieved. As a result, the increase in manufacturing costs for the tubes can be sufficiently covered.

Moreover, in the heat medium heating device according to the first aspect, the inlet header parts and the outlet header parts of the plurality of flat heat exchange tubes may be provided with communication holes that are communicated with each other when the flat heat exchange tubes are stacked, and a portion around each of the communication holes may be sealed by a seal member that is brought into close contact therewith by the pressing of the heat exchange holding member.

According to the first aspect, the inlet header parts and the outlet header parts of the plurality of flat heat exchange tubes are provided with the communication holes that are communicated with each other when the flat heat exchange tubes are stacked, and the portion around each of the communication holes is sealed by the seal member that is brought into close contact therewith by the pressing of the heat exchange holding member. Hence, even in the configuration in which the portion around each of the communication holes of the inlet header parts and the outlet header parts of the plurality of flat heat exchange tubes stacked on top of each other is sealed by the seal member such as an O-ring or a liquid gasket, the seal member can be reliably brought into close contact by the pressing of the heat exchange holding member, whereby the portion around each of the communication holes can be sealed. Accordingly, a seal structure around each of the communication holes of the inlet header parts and the outlet header parts can be simplified, and sealing properties therearound can be improved, so that the reliability of prevention of heat medium leakage can be enhanced.

Moreover, the heat medium heating device according to the first aspect may further include a control substrate that is integrally placed on a surface of the heat exchange holding member with an intermediation of an electrically insulating sheet, the control substrate having a surface on which a control circuit is mounted, the control circuit including a heat generating electrical component that controls current application to the PTC heaters.

According to the above-mentioned configuration, the control substrate having the surface on which the control circuit is mounted is integrally placed on the surface of the heat exchange holding member with the intermediation of the electrically insulating sheet. The control circuit includes the heat generating electrical component that controls current application to the PTC heaters. Hence, because the control substrate that controls current application to the PTC heaters are directly fixed and placed on the surface of the heat exchange holding member with the intermediation of the electrically insulating sheet, the control substrate can be housed and placed in the casing, without the need to provide a special substrate housing box and the like. Accordingly, the flat heat exchange tubes, the PTC heaters, the heat exchange holding member, the control substrate, and the like can be stacked to be housed and placed in the casing with a reduction in size in the stacking direction of these components, which can contribute to a reduction in size and compactification of the heat medium heating device.

Moreover, in the heat medium heating device according to the above-mentioned configuration, the heat generating electrical component mounted on the control substrate may be coolable through a heat transfer part provided to the control substrate and the electrically insulating sheet that is thermally conductive, with the heat exchange holding member made of an aluminum-alloy plate serving as a heat sink.

According to the above-mentioned configuration, the heat generating electrical component mounted on the control substrate is coolable through the heat transfer part provided to the control substrate and the thermally conductive electrically insulating sheet, with the heat exchange holding member made of the aluminum-alloy plate serving as the heat sink. Hence, heat generated by the heat generating electrical component such as a power transistor mounted on the surface of the control substrate can be transmitted to the heat exchange holding member made of the aluminum-alloy plate trough the heat transfer part and the thermally conductive electrically insulating sheet, and can be released to the heat exchange holding member side, the heat exchange holding member being in contact with substantially the entire surface of the uppermost flat heat exchange tube and serving as the heat sink. Accordingly, the heat release distance between the heat generating electrical component and the flat heat exchange tubes can be shortened, and the heat generating electrical component can be effectively cooled, so that the cooling performance, eventually, the reliability of the heat medium heating device can be improved.

Moreover, a vehicular air-conditioning device according to a second aspect of the present invention includes: a heat radiator disposed in an airflow path; and a heat medium heating device that heats a heat medium, the heated heat medium being circulatable in the heat radiator. The heat medium heating device is the heat medium heating device having any of the above-mentioned features.

According to the second aspect, the heat medium to be circulated in the heat radiator disposed in the airflow path can be heated for circulation by the heat medium heating device in which: the sealing properties are enhanced to improve the reliability of prevention of heat medium leakage; and the heat transfer efficiency is improved to achieve a reduction in size and an increase in performance. Accordingly, it is possible to improve the quality and reliability of the vehicular air-conditioning device as well as the air-conditioning performance, particularly, the air-heating performance thereof, and also improve the mountability of the air-conditioning device onto a vehicle.

### Advantageous Effects of Invention

According to the heat medium heating device of the present invention, one surface of the heat exchange holding member is brought into contact with the one surface flattened into the planar shape, of the uppermost one of the flat heat exchange tubes stacked in the plurality of layers, and substantially the entire surface of the uppermost flat heat exchange tube is substantially uniformly pressed, whereby the flat heat exchange tubes and the PTC heaters can be tightened and fixed to the inner bottom surface of the casing. Accordingly, it is possible to enhance close contact between the respective inlet header parts of the plurality of flat heat exchange tubes, between the respective outlet header parts of the flat heat exchange tubes, and between the respective flat tube parts of the flat heat exchange tubes and the PTC heaters, and thus secure sealing properties around each of the communication holes of the inlet header parts and the outlet header parts. It is also possible to reduce the thermal contact resistance between the flat heat exchange tubes and the PTC heaters to improve the heat transfer efficiency, and achieve a reduction in size and an increase in performance of the heat medium heating device. Further, because the one surface of the uppermost flat heat exchange tube is flattened, the size (thickness) in the stacking direction of the plurality of stacked flat heat exchange tubes can be reduced, and the heat medium heating device can be compactified accordingly.

Further, according to the vehicular air-conditioning device of the present invention, the heat medium to be circulated in the heat radiator disposed in the airflow path can be heated for circulation by the heat medium heating device in which: the sealing properties are enhanced; and a reduction in size and an increase in performance are achieved. Accordingly, it is possible to improve the quality and reliability of the vehicular air-conditioning device as well as the air-conditioning performance, particularly, the air-heating performance thereof, and also improve the mountability of the air-conditioning device onto a vehicle.

### BRIEF DESCRIPTION OF DRAWINGS

FIG. 1 is a schematic configuration diagram of a vehicular air-conditioning device including a heat medium heating device according to an embodiment of the present invention.

FIG. 2 is an exploded perspective view for describing procedures for assembling the heat medium heating device illustrated in FIG. 1.

FIG. 3 is a view corresponding to a longitudinal section taken along a heat medium inlet path (or a heat medium outlet path) of the heat medium heating device illustrated in FIG. 2.

FIG. 4 is an exploded perspective view illustrating a state where flat heat exchange tubes of the heat medium heating device illustrated in FIG. 2 are stacked and incorporated.

FIG. 5 is a side view illustrating a state where an internal structure incorporated in a casing of the heat medium heating device illustrated in FIG. 3 is taken out in its assembled state.

FIG. 6 is a side view illustrating a state where only three flat heat exchange tubes of the internal structure illustrated in FIG. 5 are taken out.

### DESCRIPTION OF EMBODIMENTS

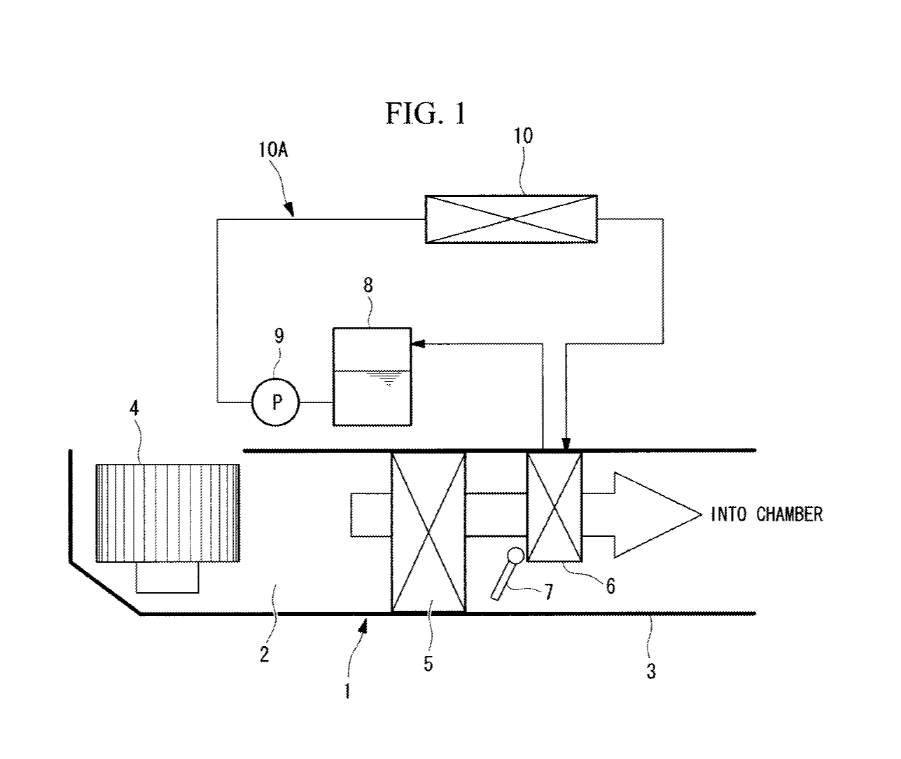

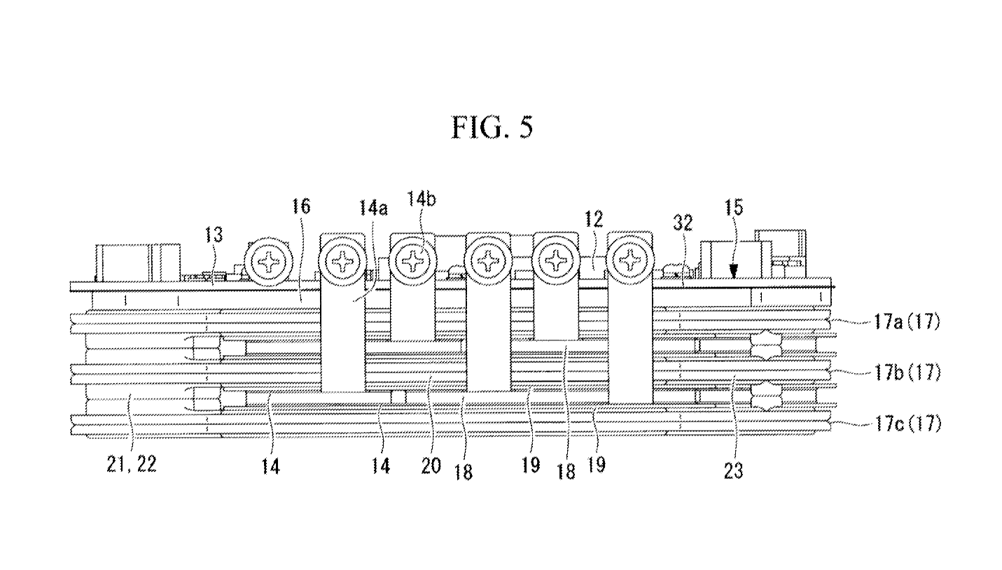

Hereinafter, an embodiment of the present invention is described with reference to FIG. 1 to FIG. 6.

FIG. 1 is a schematic configuration diagram of a vehicular air-conditioning device including a heat medium heating device according to the embodiment of the present invention.

A vehicular air-conditioning device 1 includes a casing 3 that forms an air circulation path 2 for taking therein external air or air in a chamber, regulating the temperature thereof, and then guiding the air into the chamber.

A blower 4, a cooler 5, a heat radiator 6, and an air mix damper 7 are placed in the stated order from the upstream side to the downstream side of the air circulation path 2 inside of the casing 3. The blower 4 suctions external air or air in the chamber, increases the pressure thereof, and sends under pressure the resultant air to the downstream side. The cooler 5 cools the air sent under pressure by the blower 4. The heat radiator 6 heats the air that is cooled while passing through the cooler 5. The air mix damper 7 adjusts the flow ratio of the amount of air passing through the heat radiator 6 to the amount of air bypassing the heat radiator 6, and mixes the two flows of air downstream of the heat radiator 6, to thereby regulate the temperature of air.

The downstream side of the casing 3 is connected to a plurality of blow-out ports that blow out, into the chamber, the temperature-regulated air through a blow-out mode switching damper and a duct, which are not illustrated.

The cooler 5 constitutes a refrigerant circuit together with a compressor, a condenser, and an expansion valve, which are not illustrated, and the cooler 5 evaporates a refrigerant adiabatically expanded by the expansion valve, to thereby cool air passing therethrough. Further, the heat radiator 6 constitutes a heat medium circulation circuit 10A together with a tank 8, a pump 9, and a heat medium heating device 10. A heat medium (for example, antifreeze liquid or warm water) that is heated to a high temperature by the heat medium heating device 10 is circulated in the heat medium circulation circuit 10A by the pump 9, whereby the heat radiator 6 warms air passing therethrough.

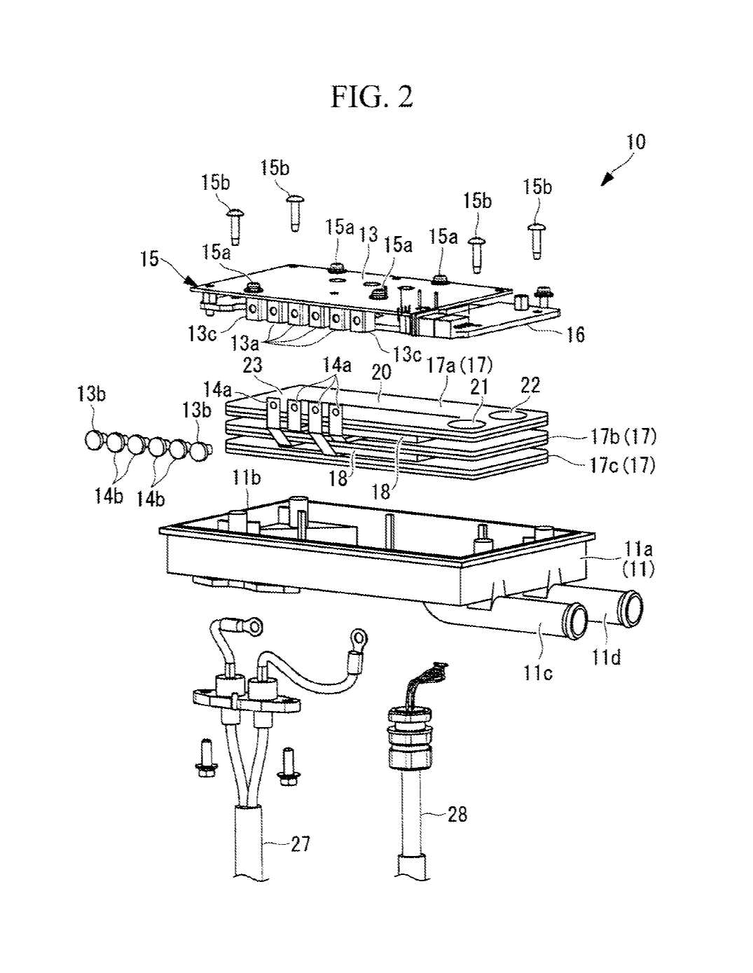

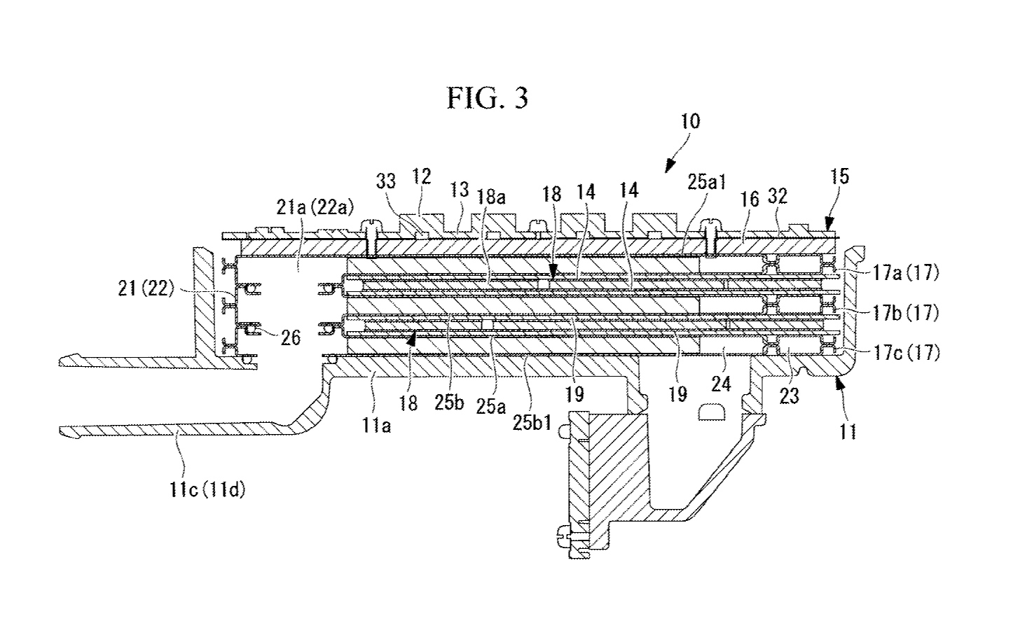

FIG. 2 is an exploded perspective view for describing procedures for assembling the heat medium heating device 10 illustrated in FIG. 1, and FIG. 3 is a view corresponding to a longitudinal section taken along a heat medium inlet path (or a heat medium outlet path) of the heat medium heating device 10.

As illustrated in FIG. 2, the heat medium heating device 10 includes: a control substrate 13; a plurality of electrode plates 14 (see FIG. 3); a plurality of power transistors (heat generating electrical components) 12 (see FIG. 3) such as IGBTs disposed on the control substrate 13; a heat exchange holding member 16; a plurality of (in the present embodiment, three) flat heat exchange tubes 17; a plurality of PTC elements 18a (see FIG. 3); and a casing 11 for housing and placing therein the control substrate 13, the electrode plates 14, the power transistors 12, the flat heat exchange tubes 17, the heat exchange holding member 16, the PTC elements 18a, and the like.

Note that each PTC heater 18 is configured by the electrode plates 14, the PTC element 18a, electrically insulating members (not illustrated), and the like.

The casing 11 is divided in two, that is, an upper half part and a lower half part, and thus includes an upper case (not illustrated) constituting the upper half part and a lower case 11a constituting the lower half part. The upper case is put in an opening part 11b of the lower case 11a from above the lower case 11a, whereby a space for housing the control substrate 13, the power transistors (heat generating electrical components) 12, the electrode plates 14, the heat exchange holding member 16, the plurality of flat heat exchange tubes 17, the plurality of PTC heaters 18, and the like is formed inside of the upper case and the lower case 11a.

A heat medium inlet path 11c and a heat medium outlet path 11d are integrally formed on the bottom surface of the lower case 11a. The heat medium inlet path 11c serves to guide the heat medium to be introduced into the three stacked flat heat exchange tubes 17, and the heat medium outlet path 11d serves to guide the heat medium that has circulated in the flat heat exchange tubes 17 to the outside. The heat medium inlet path 11c and the heat medium outlet path 11d are extended from the bottom surface of the lower case 11a in parallel to each other in the same horizontal direction, and protrude laterally from one end of the lower case 11a. Note that the upper case and the lower case 11a are molded using a resin material (for example, PPS) having a coefficient of linear expansion close to that of an aluminum alloy material forming the flat heat exchange tubes 17 housed in the space inside of the upper case and the lower case 11a. Because the casing 11 is made of the resin material in this way, a reduction in weight can be achieved.

Further, power supply harness holes (not illustrated) and a LV harness hole (not illustrated) are opened in the lower surface of the lower case 11a, and respectively allow leading end parts of a power supply harness 27 and a LV harness 28 to pass therethrough. The power supply harness 27 supplies electric power to the PTC heaters 18 through the control substrate 13 and the power transistors 12 such as the IGBTs. The leading end part of the power supply harness 27 is bifurcated, and the two ends thereof can be respectively fixed to two power supply harness terminal mounts 13c provided to the control substrate 13, using power supply harness connection screws 13b. Further, the LV harness 28 transmits a control signal to the control substrate 13, and the leading end part thereof can be connector-connected to the control substrate 13.

The power transistors 12 such as the IGBTs and the control substrate 13 constitute a control circuit that controls current application to the plurality of PTC heaters 18 on the basis of a command from an upper control unit (ECU), and whether or not to apply current to the plurality of PTC heaters 18 can be switched through the plurality of power transistors 12 such as the IGBTs. Then, the plurality of flat heat exchange tubes 17 are stacked so as to sandwich each of the plurality of PTC heaters 18.

The flat heat exchange tubes 17 are made of an aluminum alloy material, and, as illustrated in FIG. 2 to FIG. 4, lower, middle, and upper flat heat exchange tubes 17c, 17b, and 17a (three flat heat exchange tubes 17) are stacked in the stated order in parallel to each other. As illustrated in FIG. 2 to FIG. 4, the flat heat exchange tubes 17 each include: an inlet header part 21 and an outlet header part 22 that are provided next to each other at one end of a flat tube part 20; and a U-turn part 23 that is formed at another end of the flat tube part 20 and causes a flow of the heat medium to make a U-turn. A U-turn flow path 24 is formed in the flat tube part 20 so as to run from the inlet header part 21 to the outlet header part 22 through the U-turn part 23.

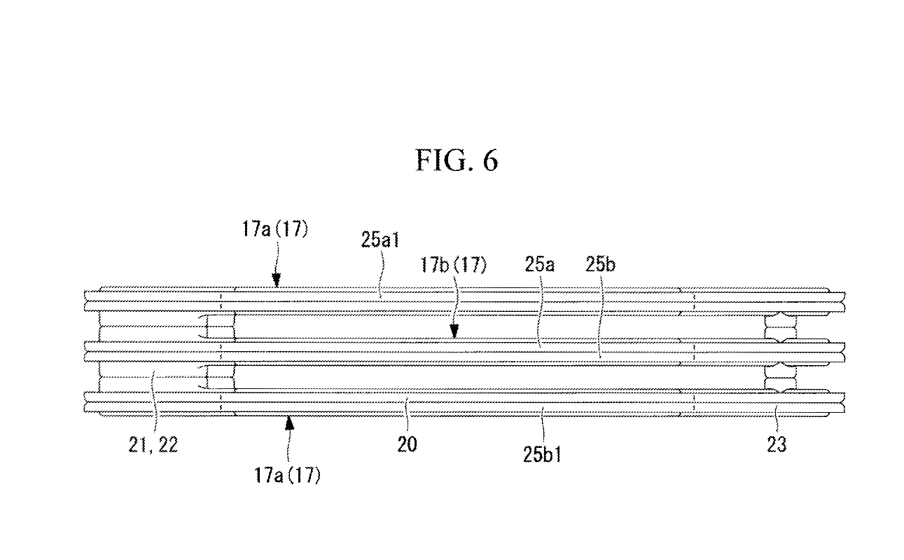

As illustrated in FIG. 3 and FIG. 6, each flat heat exchange tube 17 is formed by putting a pair of molded plate members 25a and 25b each made of an aluminum-alloy thin plate on top of each other and brazing the molded plate members 25a and 25b to each other. The molded plate members 25a and 25b include the flat tube part 20, the inlet header part 21, and the outlet header part 22 that are integrally formed by press molding. The size in the thickness direction of each of the inlet header parts 21 and the outlet header parts 22 molded in the molded plate members 25a and 25b other than a molded plate member 25a1 and a molded plate member 25b1, among all the molded plate members 25a and 25b, is set to be larger than the size in the thickness direction of the flat tube part 20 forming the U-turn flow path 24. The molded plate member 25a1 constitutes the upper surface of the uppermost flat heat exchange tube 17a, and the molded plate member 25b1 constitutes the lower surface of the lowermost flat heat exchange tube 17c.

With this configuration, when the three flat heat exchange tubes 17a, 17b, and 17c are stacked, a gap having a predetermined size is formed between the adjacent flat tube parts 20. Each PTC heater 18 that is sandwiched by the electrode plates 14 and thermally conductive electrically insulating sheets 19 from above and below the PTC heater 18 is interposed in this gap, whereby the three flat heat exchange tubes 17 and the two PTC heaters 18 are stacked in a plurality of layers.

Meanwhile, the molded plate member 25a1 constituting the upper surface of the uppermost flat heat exchange tube 17a and the molded plate member 25b1 constituting the lower surface of the lowermost flat heat exchange tube 17c respectively serve as contact surfaces with the lower surface (rear surface) of the heat exchange holding member 16 and the inner bottom surface of the lower case 11a, and receive pressing force of the heat exchange holding member 16. Hence, the upper surface of the molded plate member 25a1 and the lower surface of the molded plate member 25b1 are each formed into a planar shape in which the inlet header part 21, the outlet header part 22, and the flat tube part 20 are flattened. With this configuration, the pressing force can be substantially uniformly received by substantially the entire surfaces of the molded plate members 25a1 and 25b1, which makes it possible to reliably bring: the flat heat exchange tubes 17 and the PTC heaters 18 stacked in the plurality of layers; the respective inlet header parts 21 of the flat heat exchange tubes 17; and the outlet header parts 22 of the flat heat exchange tubes 17, into close contact with each other.

Further, when the flat heat exchange tubes 17 are stacked, as illustrated in FIGS. 3, 5, and 6, the respective inlet header parts 21 thereof are in close contact with each other, and the respective outlet header parts 22 thereof are in close contact with each other. Consequently, communication holes 21a provided to the inlet header parts 21 are communicated with each other, and communication holes 22a provided to the outlet header parts 22 are communicated with each other. At this time, the communication holes 21a and 22a are each sealed by a seal member 26 such as an O-ring, a gasket, or a liquid gasket (in the present embodiment, the O-ring is used) disposed therearound.

Between the respective inlet header parts 21 (outlet header parts 22) of the flat heat exchange tube 17a and the flat heat exchange tube 17b, the seal member (O-ring) 26 is placed around the communication hole 21a (22a) on the side of the molded plate member 25b constituting the flat heat exchange tube 17b. Between the respective inlet header parts (outlet header parts 22) of the flat heat exchange tube 17b and the flat heat exchange tube 17c, the seal member (O-ring) 26 is placed around the communication hole 21a (22a) on the side of the molded plate member 25b constituting the flat heat exchange tube 17c. Between the inlet header part 21 (outlet header part 22) of the flat heat exchange tube 17c and the inner bottom surface of the lower case 11a, the seal member (O-ring) 26 is placed in a disposition portion for the seal member 26 formed on the inner bottom surface of the lower case 11a.

Moreover, an inlet temperature sensor 29 and an outlet temperature sensor 30 are provided to the lowermost flat heat exchange tube 17c of the three stacked flat heat exchange tubes 17. The inlet temperature sensor 29 detects the temperature of the heat medium that has flown into the heat medium heating device 10 from the heat medium inlet path 11c and has not yet been branched into the three flat heat exchange tubes 17a, 17b, and 17c from the respective inlet header parts 21. The outlet temperature sensor 30 detects the temperature of the branched heat mediums that have circulated in the three flat heat exchange tubes 17a, 17b, and 17c, have been heated by the PTC heaters 18, have joined together in the outlet header parts 22, and then flow out of the heat medium heating device 10.

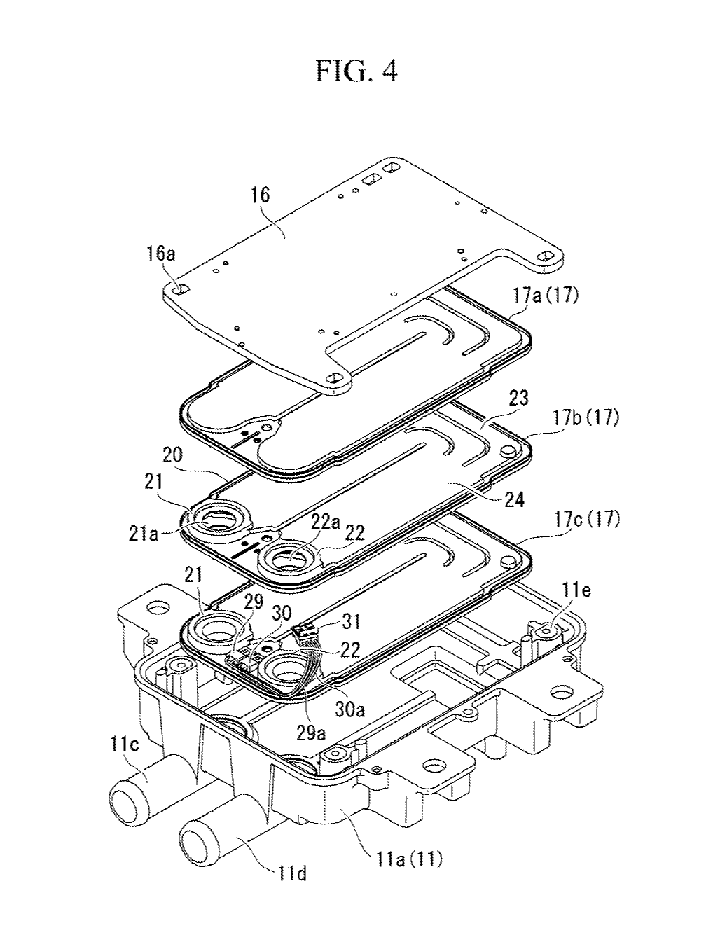

As illustrated in FIG. 4, the inlet temperature sensor 29 and the outlet temperature sensor 30 are adjacently provided next to each other in a space part around and between the inlet header part 21 and the outlet header part 22 that are provided next to each other at one end of the lowermost flat heat exchange tube 17c. Note that the space part is provided with a slit (not illustrated) for insulating heat conduction between a portion in which the inlet temperature sensor 29 is placed and a portion in which the outlet temperature sensor 30 is placed, whereby thermal interference is prevented. Values detected by the inlet temperature sensor 29 and the outlet temperature sensor 30 are fed to the control substrate 13 through lead wires 29a and 30a and a connector 31 provided at an end of the lead wires 29a and 30a.

Further, the plurality of PTC heaters 18 are respectively incorporated in the following manner into the gaps between the flat tube parts 20 of the three flat heat exchange tubes 17 with the intermediation of the electrode plates 14 and the thermally conductive electrically insulating sheets 19.

As illustrated in FIG. 3, the electrode plates 14 serve to supply electric power to the PTC element 18a, and are plate members that are rectangular in plan view and made of an aluminum alloy. The electrode plates 14 sandwich the PTC element 18a. Specifically, one electrode plate 14 is stacked in contact with the upper surface of the PTC element 18a, and another one electrode plate 14 is stacked in contact with the lower surface of the PTC element 18a. These two electrode plates 14 sandwich the upper surface and the lower surface of the PTC element 18a from above and below the PTC element 18a.

Then, the electrode plate 14 arranged on the upper surface side of the PTC element 18a is arranged such that the upper surface thereof is in contact with the lower surface of one of the flat heat exchange tubes 17 with the intermediation of the thermally conductive electrically insulating sheet 19. The electrode plate 14 arranged on the lower surface side of the PTC element 18a is arranged such that the lower surface thereof is in contact with the upper surface of another one of the flat heat exchange tubes 17 with the intermediation of the thermally conductive electrically insulating sheet 19. In the present embodiment, two electrode plates 14 are arranged between the lower flat heat exchange tube 17c and the middle flat heat exchange tube 17b, and two electrode plates 14 are arranged between the middle flat heat exchange tube 17b and the upper flat heat exchange tube 17a. That is, the total number of the electrode plates 14 is four. The PTC heaters 18 sandwiched by the electrode plates 14 are respectively stacked and disposed between the flat tube parts 20 of the three flat heat exchange tubes 17.

The four electrode plates 14 each have substantially the same shape as that of the flat tube part 20 of each flat heat exchange tube 17. Each electrode plate 14 is provided with terminals 14a (see FIG. 2) on its longer side. The terminals 14a are arranged along the longer side direction of the electrode plates 14 so as not to overlap with each other when the electrode plates 14 are stacked. That is, the positions of the terminals 14a provided to the electrode plates 14 are slightly different from each other in the longer side direction, and the terminals 14a are arranged in a line when the electrode plates 14 are stacked. Each terminal 14a is provided so as to protrude upward, and is connected to a terminal mount 13a provided to the control substrate 13, using a terminal connection screw 14b.

A substrate sub-assembly 15 is integrated by sandwiching a thermally conductive electrically insulating sheet 32 by the control substrate 13 and the heat exchange holding member 16 and tightening the resultant structure using, for example, four substrate sub-assembly connection screws 15a. Note that the power transistors 12 such as the IGBTs provided on the control substrate 13 are heat generating electrical components, and heat generated thereby passes through heat transfer parts 33 that are provided to the control substrate 13 correspondingly to placement parts for the power transistors 12, and is released to the heat exchange holding member 16 side. Consequently, with the heat exchange holding member 16 serving as a heat sink, the generated heat is cooled by the heat medium circulating in the flat heat exchange tubes 17.

Further, the control substrate 13 constituting the substrate sub-assembly 15 is provided with four terminal mounts 13a that are arranged in a line on one side thereof correspondingly to the four terminals 14a that are arranged in a line on the electrode plates 14. Further, the two power supply harness terminal mounts 13c respectively connected to the bifurcated leading end parts of the power supply harness 27 are provided so as to be arranged in a line on both end sides of the four terminal mounts 13a. The terminal mounts 13a and the power supply harness terminal mounts 13c are provided so as to protrude downward (or upward) from the control substrate 13. Further, the terminal mounts 13a and the terminal mounts 13c are disposed in a line along the longer sides of the stacked flat heat exchange tubes 17a, 17b, and 17c.

Moreover, the terminal mounts 13a and 13c or connection parts for the LV harness 28 and the lead wires 29a and 30a of the inlet temperature sensor 29 and the outlet temperature sensor 30, which are provided to the control substrate 13, are located at a position slightly above the opening part 11b of the lower case 11a. With this configuration, the terminals 14a of the electrode plates 14 and the leading end parts of the power supply harness 27 are more easily connected to the terminal mounts 13a and the power supply harness terminal mounts 13c, or the LV harness 28 and the lead wires 29a and 30a are more easily connected to the connection parts.

Meanwhile, the heat exchange holding member 16 constituting the substrate sub-assembly 15 is a flat plate member that is rectangular in plan view and made of an aluminum alloy. As described above, the control substrate 13 is arranged on the upper surface of the heat exchange holding member 16 with the intermediation of the thermally conductive electrically insulating sheet 32. As illustrated in FIG. 4, the heat exchange holding member 16 has a size large enough to cover the upper surfaces of the flat tube part 20, the inlet header part 21, and the outlet header part 22 of each flat heat exchange tube 17. Long through-holes 16a are respectively provided in four corner parts of the heat exchange holding member 16. The long through-holes 16a respectively allow substrate sub-assembly fixing screws 15b to pass therethrough. The substrate sub-assembly fixing screws 15b serve to fix the heat exchange holding member 16 to boss parts 11e of the lower case 11a.

The substrate sub-assembly 15 is put on the upper surface of the stacked uppermost flat heat exchange tube 17a, and is disposed such that the lower surface of the heat exchange holding member 16 is in contact with substantially the entire flattened upper surface (one surface) including the flat tube part 20, the inlet header part 21, and the outlet header part 22 of the uppermost flat heat exchange tube 17a. In the configuration of the substrate sub-assembly 15, if the heat exchange holding member 16 is screwed to the boss parts 11e of the lower case 11a, between the lower surface of the heat exchange holding member 16 and the inner bottom surface of the lower case 11a, the respective flat tube parts 20 of the three stacked flat heat exchange tubes 17 and the two PTC heaters 18 sandwiched therebetween can be pressed and brought into close contact with each other, and the seal member (in the present embodiment, the O-ring) 26 that is disposed around each of the communication holes 21a and 22a provided to the inlet header part 21 and the outlet header part 22 of each flat heat exchange tube 17 can be brought into close contact for tightening and fixing.

With this configuration, the heat medium that has flown in from the heat medium inlet path 11c circulates in the following flow path. The heat medium is introduced into the flat tube part 20 from the inlet header part 21 of each flat heat exchange tube 17, is heated by the PTC heater 18 to have a higher temperature while circulating in the U-turn flow path 24 of the flat tube part 20, reaches the outlet header part 22, and passes through the outlet header part 22 and then the heat medium outlet path 11d to flow to the outside. The heat medium that has flown out of the heat medium heating device 10 is supplied to the heat radiator 6 through the heat medium circulation circuit 10A (see FIG. 1).

Further, the heat exchange holding member 16 constituting the substrate sub-assembly 15 is made of an aluminum-alloy plate having excellent heat conductivity, and the lower surface thereof is in contact with the flattened upper surface of the uppermost flat heat exchange tube 17a. With this configuration, the heat medium flowing in each flat heat exchange tube 17 as described above serves as a cooling heat source for the heat exchange holding member 16, and the heat exchange holding member 16 also functions as a heat sink for cooling the power transistors (heat generating electrical components) 12 placed on the control substrate 13.

In the heat medium heating device 10 described above, the three flat heat exchange tubes 17 and the two PTC heaters 18 can be incorporated into the lower case 11a in the following manner.

First, the seal member 26 is arranged around each of opening parts of the heat medium inlet path 11c and the heat medium outlet path 11d opened in the inner bottom surface of the lower case 11a, and the lowermost flat heat exchange tube 17c is put thereon. The lower surface of the lowermost flat heat exchange tube 17c in contact with the inner bottom surface of the lower case 11a is flattened into a planar shape, and hence the lowermost flat heat exchange tube 17c is arranged with substantially the entire lower surface thereof being in contact with the inner bottom surface of the lower case 11a. If the inlet temperature sensor 29 and the outlet temperature sensor 30 are attached in advance to the lowermost flat heat exchange tube 17c, the inlet temperature sensor 29 and the outlet temperature sensor 30 can be incorporated at the same time.

Next, the thermally conductive electrically insulating sheet 19, the PTC heater 18, the seal members 26, and the like are arranged on the upper surface of the lowermost flat heat exchange tube 17c. The middle flat heat exchange tube 17b is stacked thereon. The thermally conductive electrically insulating sheet 19, the PTC heater 18, the seal members 26, and the like are further arranged on the upper surface of the middle flat heat exchange tube 17b. The uppermost flat heat exchange tube 17a is stacked thereon. As a result, the three flat heat exchange tubes 17a, 17b, and 17c and the upper and lower two PTC heaters 18 can be stacked and incorporated in the plurality of layers with the seal member 26 being disposed around each of the communication holes 21a and 22a of the inlet header parts 21 and the outlet header parts 22.

In this way, the three flat heat exchange tubes 17 and the two PTC heaters 18 are incorporated at predetermined positions on the inner bottom surface of the lower case 11a. After that, the substrate sub-assembly 15 is put on the upper surface of the uppermost flat heat exchange tube 17a, and the heat exchange holding member 16 of the substrate sub-assembly 15 is tightened and fixed to the boss parts 11e of the lower case 11a using the four fixing screws 15b. In this manner, the components can be incorporated in the lower case 11a in the state where the pressing force of the heat exchange holding member 16 brings: the respective flat tube parts 20 of the three flat heat exchange tubes 17 and the PTC heaters 18; the three seal members 26 respectively disposed around the communication holes 21a of the inlet header parts 21 of the flat heat exchange tubes 17 and the inlet header parts 21; and the three seal members 26 respectively disposed around the communication holes 22a of the outlet header parts 22 of the flat heat exchange tubes 17 and the outlet header parts 22, into close contact with each other.

The upper surface (one surface) of the uppermost flat heat exchange tube 17a is flattened into a planar shape. Hence, when the substrate sub-assembly 15 is put on the upper surface of the uppermost flat heat exchange tube 17a and when the three flat heat exchange tubes 17 and the two PTC heaters 18 stacked in the plurality of layers are pressed for tightening and fixing by the lower surface (rear surface) of the heat exchange holding member 16 toward the inner bottom surface of the lower case 11a, substantially the entire upper surface of the uppermost flat heat exchange tube 17a can be substantially uniformly pressed for tightening and fixing. As a result, it is possible to simultaneously secure close contact between the flat tube parts 20 and the PTC heaters 18, between the respective inlet header parts 21 of the flat heat exchange tubes 17 and the seal members 26, and between the respective outlet header parts 22 of the flat heat exchange tubes 17 and the seal members 26.

After that, the terminals of the power supply harness 27 and the terminals 14a of the electrode plates 14 are respectively fixed to the terminal mounts 13a and 13c of the control substrate 13 provided on the upper surface of the heat exchange holding member 16, using the screws 13b and 14b. Further, the LV harness 28, the lead wires 29a and 30a of the inlet temperature sensor 29 and the outlet temperature sensor 30, and the like are connector-connected for connection of electrical lines. The upper case (not illustrated) is screwed to the lower case 11a so as to cover an upper portion of the resultant structure. In this manner, the heat medium heating device 10 can be assembled.

As illustrated in FIG. 1, the heat medium heating device 10 is incorporated into the heat medium circulation circuit 10A of the vehicular air-conditioning device 1. Then, in the heat medium heating device 10, the heat medium that has flown into the inlet header parts 21 through the heat medium inlet path 11c is branched into the three flat heat exchange tubes 17a, 17b, and 17c from the respective inlet header parts 21. The branched heat mediums respectively circulate in the three flat heat exchange tubes 17a, 17b, and 17c, and are heated by the plurality of PTC heaters 18. Then, the branched heat mediums join together in the outlet header parts 22, and flow out through the heat medium outlet path 11d. In this manner, the heat medium heating device 10 serves to heat the heat medium circulating in the heat medium circulation circuit 10A.

At this time, the temperature of the heat medium to be circulated in the heat medium heating device 10 and the temperature of the heat medium that is heated by the heat medium heating device 10 to be supplied to the heat radiator 6 can be detected by the paired inlet temperature sensor 29 and outlet temperature sensor 30 disposed around the inlet header part 21 and the outlet header part 22 of the lowermost flat heat exchange tube 17c. Accordingly, the heat medium heating device 10 (for example, the amount of heat applied by the plurality of PTC heaters 18) can be controlled on the basis of the detected temperatures.

The heat medium heating device 10 and the vehicular air-conditioning device 1 of the present embodiment produce the following operations and effects.

According to the heat medium heating device 10 of the present embodiment, the plurality of flat heat exchange tubes 17 and the plurality of PTC heaters 18 are alternately stacked in the plurality of layers, and the heat exchange holding member 16 presses the upper surface (one surface) of the uppermost flat heat exchange tube 17a, whereby the flat heat exchange tubes 17 and the PTC heaters 18 are tightened and fixed to the inner bottom surface of the casing 11 (lower case 11a). In the heat medium heating device 10 thus configured, at least the uppermost flat heat exchange tube 17a of the plurality of stacked flat heat exchange tubes 17 has the upper surface (one surface) pressed by the heat exchange holding member 16, the upper surface (one surface) being formed into the planar shape in which the inlet header part 21, the outlet header part 22, and the flat tube part 20 are flattened.

Accordingly, the lower surface (one surface) of the heat exchange holding member 16 is brought into contact with the one surface flattened into such a planar shape, of the uppermost one 17a of the flat heat exchange tubes stacked in the plurality of layers, and substantially the entire surface of the uppermost flat heat exchange tube 17a is substantially uniformly pressed, whereby the flat heat exchange tubes 17 and the PTC heaters 18 can be tightened and fixed to the inner bottom surface of the lower case 11a. Accordingly, it is possible to enhance close contact between the respective inlet header parts 21 of the plurality of flat heat exchange tubes 17, between the respective outlet header parts 22 of the flat heat exchange tubes 17, and between the respective flat tube parts 20 of the flat heat exchange tubes 17 and the PTC heaters 18, and thus secure sealing properties of the seal member (O-ring) 26 around each of the communication holes 21a and 22a of the inlet header parts 21 and the outlet header parts 22. It is also possible to reduce the thermal contact resistance between the flat heat exchange tubes 17 and the PTC heaters 18 to improve the heat transfer efficiency, and achieve a reduction in size and an increase in performance of the heat medium heating device 10.

Further, because the upper surface (one surface) of the uppermost flat heat exchange tube 17a is flattened, the size (thickness) in the stacking direction of the plurality of stacked flat heat exchange tubes 17 can be reduced, and the heat medium heating device 10 can be compactified accordingly.

Similarly, the lowermost flat heat exchange tube 17c of the flat heat exchange tubes 17 stacked in the plurality of layers has the lower surface (one surface) in contact with the inner bottom surface of the lower case 11a, the lower surface (one surface) being formed into the planar shape in which the inlet header part 21, the outlet header part 22, and the flat tube part 20 are flattened. Accordingly, when the heat exchange holding member 16 presses the upper surface of the uppermost flat heat exchange tube 17a, to thereby tighten and fix the flat heat exchange tubes 17 and the PTC heaters 18 stacked on top of each other to the inner bottom surface of the lower case 11a, the flattened lower surface of the lowermost flat heat exchange tube 17c is brought into contact with the inner bottom surface of the lower case 11a, and the pressing force of the heat exchange holding member 16 can be substantially uniformly received by substantially the entire lower surface of the lowermost flat heat exchange tube 17c.

Also with this configuration, it is possible to enhance close contact between the respective inlet header parts 21 of the flat heat exchange tubes 17, between the respective outlet header parts 22 of the flat heat exchange tubes 17, and between the respective flat tube parts 20 of the flat heat exchange tubes 17 and the PTC heaters 18, and thus secure sealing properties around each of the communication holes 21a and 22a of the inlet header parts 21 and the outlet header parts 22. It is also possible to reduce the thermal contact resistance between the flat heat exchange tubes 17 and the PTC heaters 18 to improve the heat transfer efficiency, and achieve a reduction in size and an increase in performance of the heat medium heating device 10. Further, because the one surface of the lowermost flat heat exchange tube 17c is flattened, the size (thickness) in the stacking direction of the plurality of stacked flat heat exchange tubes 17 can be reduced, and the heat medium heating device 10 can be compactified accordingly.

Further, the plurality of flat heat exchange tubes 17 are each formed by attaching the pair of molded plate members 25a and 25b including the inlet header part 21, the outlet header part 22, and the flat tube part 20 that are integrally formed by press molding. The inlet header part 21, the outlet header part 22, and the flat tube part 20 that are molded in one 25a1 of the molded plate members constituting the uppermost flat heat exchange tube 17a and/or one 25b1 of the molded plate members constituting the lowermost flat heat exchange tube 17c are flattened into the planar shape. Hence, if the molded plate member 25a1 (25b1) of the pair of molded plate members 25a and 25b constituting the uppermost flat heat exchange tube 17a (lowermost flat heat exchange tube 17c) is changed, the uppermost flat heat exchange tube 17a and/or the lowermost flat heat exchange tube 17c including the flattened inlet header part 21, outlet header part 22, and flat tube part 20 can be manufactured.

That is, if the inlet header part 21 and the outlet header part 22 that are molded in the molded plate member 25a1 (25b1) of the pair of molded plate members 25a and 25b constituting the flat heat exchange tube 17 are configured to have the same planar height as that of the flat tube part 20, the uppermost flat heat exchange tube 17a and/or the lowermost flat heat exchange tube 17c including the flattened inlet header part 21, outlet header part 22, and flat tube part 20 can be manufactured. Accordingly, although two different types of flat heat exchange tube (that is, 17a (17c) and 17b) need to be manufactured and manufacturing costs for the tubes thus increase, the size in the stacking direction of the flat heat exchange tubes 17 can be reduced, and a reduction in size and an increase in performance of the heat medium heating device 10 can be achieved. As a result, the increase in manufacturing costs for the tubes can be sufficiently covered.

Moreover, in the present embodiment, the inlet header parts 21 and the outlet header parts 22 of the plurality of flat heat exchange tubes 17 are respectively provided with the communication holes 21a and 22a that are communicated with each other when the flat heat exchange tubes 17 are stacked, and the portion around each of the communication holes 21a and 22a is sealed by the seal member 26 that is brought into close contact therewith by the pressing of the heat exchange holding member 16. Hence, even in the configuration in which the portion around each of the communication holes 21a and 22a of the inlet header parts 21 and the outlet header parts 22 of the plurality of flat heat exchange tubes 17 stacked on top of each other is sealed by the seal member 26 such as an O-ring or a liquid gasket, the seal member 26 can be reliably brought into close contact by the pressing of the heat exchange holding member 16, whereby the portion around each of the communication holes 21a and 22a can be sealed. Accordingly, a seal structure around each of the communication holes 21a and 22a of the inlet header parts 21 and the outlet header parts 22 can be simplified, and sealing properties therearound can be improved, so that the reliability of prevention of heat medium leakage can be enhanced.

Further, the control substrate 13 having a surface on which the control circuit is mounted is integrally placed on the upper surface of the heat exchange holding member 16 with the intermediation of the thermally conductive electrically insulating sheet 32. The control circuit includes the power transistors 12 as the heat generating electrical components that control current application to the PTC heaters 18. Hence, because the control substrate 13 that controls current application to the PTC heaters 18 are directly fixed and placed on the upper surface of the heat exchange holding member 16 with the intermediation of the electrically insulating sheet 32, the control substrate 13 can be housed and placed in the casing 11, without the need to provide a special substrate housing box and the like. Accordingly, the flat heat exchange tubes 17, the PTC heaters 18, the heat exchange holding member 16, the control substrate 13, and the like can be stacked to be housed and placed in the casing 11 with a reduction in size in the stacking direction of these components, which can contribute to a reduction in size and compactification of the heat medium heating device 10.

Further, in the present embodiment, the power transistors (heat generating electrical components) 12 mounted on the control substrate 13 are coolable through the heat transfer parts 33 provided to the control substrate 13 and the thermally conductive electrically insulating sheet 32, with the heat exchange holding member 16 made of the aluminum-alloy plate serving as the heat sink. Hence, heat generated by the power transistors (heat generating electrical components) 12 mounted on the surface of the control substrate 13 can be transmitted to the heat exchange holding member 16 made of the aluminum-alloy plate trough the heat transfer parts 33 and the thermally conductive electrically insulating sheet 32, and can be released to the heat exchange holding member 16 that is in contact with substantially the entire surface of the uppermost flat heat exchange tube 17a and serves as the heat sink. Accordingly, the heat release distance between the heat generating electrical components 12 and the flat heat exchange tube 17a can be shortened, and the heat generating electrical components 12 can be effectively cooled, so that the cooling performance, eventually, the reliability of the heat medium heating device 10 can be improved.

Moreover, according to the vehicular air-conditioning device 1 of the present embodiment, the heat medium to be circulated in the heat radiator 6 disposed in the airflow path 2 can be heated for circulation by the heat medium heating device 10 in which: the sealing properties are enhanced to improve the reliability of prevention of heat medium leakage; and the heat transfer efficiency is improved to achieve a reduction in size and an increase in performance. Accordingly, it is possible to improve the quality and reliability of the vehicular air-conditioning device 1 as well as the air-conditioning performance, particularly, the air-heating performance thereof, and also improve the mountability of the air-conditioning device 1 onto a vehicle.

Note that the present invention is not limited to the invention according to the above-mentioned embodiment, and can be modified as appropriate within the range not departing from the scope of the present invention. For example, in the above-mentioned embodiment, the flat heat exchange tubes 17 are stacked in three layers, and the PTC heater 18 is incorporated into each gap between the adjacent flat heat exchange tubes 17. The present invention is not limited thereto, and the stacking number of the flat heat exchange tubes 17 and the PTC heaters 18 may be increased or decreased, as a matter of course. Further, the example in which the casing 11 is a resin molded article is described above. The present invention is not limited thereto, and the casing 11 may be made of metal such as an aluminum alloy, as a matter of course.

Moreover, in the above-mentioned embodiment, the example in which the flat heat exchange tubes 17 having a one-end header structure are used is described. In the one-end header structure, the inlet header part 21 and the outlet header part 22 are provided next to each other at one end of the flat tube part 20, and the U-turn flow path 24 is formed in the flat tube part 20. Alternatively, flat heat exchange tubes having a both-end header structure may be used. In the both-end header structure, the inlet header part 21 and the outlet header part 22 are separately provided at both ends of the flat tube part 20.

### REFERENCE SIGNS LIST

1 vehicular air-conditioning device
6 heat radiator
10 heat medium heating device
10A heat medium circulation circuit
11 casing
11a lower case
12 power transistor (heat generating electrical component)
13 control substrate
16 heat exchange holding member
17, 17a, 17b, 17c flat heat exchange tube
(17a uppermost flat heat exchange tube, 17c lowermost flat heat exchange tube)
18 PTC heater
20 flat tube part
21 inlet header part
21a communication hole
22 outlet header part
22a communication hole
25a, 25b pair of molded plate members
25a1 one of molded plate members constituting uppermost flat heat exchange tube
25b1 one of molded plate members constituting lowermost flat heat exchange tube
26 seal member
32 electrically insulating sheet
33 heat transfer part

1. A heat medium heating device comprising:
a plurality of flat heat exchange tubes each including:
an inlet header part from which a heat medium flows into the flat heat exchange tube;
a flat tube part in which the heat medium circulates; and
an outlet header part from which the heat medium flows out of the flat heat exchange tube;
PTC heaters that are respectively incorporated to between the flat tube parts of the plurality of flat heat exchange tubes;
a casing in which the flat heat exchange tubes and the PTC heaters are alternately stacked and incorporated in a plurality of layers; and
a heat exchange holding member that presses the flat heat exchange tubes stacked in the plurality of layers from one side thereof, to thereby tighten and fix the flat heat exchange tubes to an inner bottom surface of the casing, wherein
at least an uppermost flat heat exchange tube of the plurality of stacked flat heat exchange tubes has one surface pressed by the heat exchange holding member, the one surface being formed into a planar shape in which the inlet header part, the outlet header part, and the flat tube part are flattened.

2. The heat medium heating device according to claim 1, wherein
a lowermost flat heat exchange tube of the flat heat exchange tubes stacked in the plurality of layers has one surface in contact with the inner bottom surface of the casing, the one surface being formed into a planar shape in which the inlet header part, the outlet header part, and the flat tube part are flattened.

3. The heat medium heating device according, to claim 1, wherein
the plurality of flat heat exchange tubes are each formed by attaching a pair of molded plate members including the inlet header part, the outlet header part, and the flat tube part that are integrally formed by press molding, and
the inlet header part, the outlet header part, and the flat tube part that are molded in one of the molded plate members constituting the uppermost flat heat exchange tube and/or the lower most flat heat exchange tube are flattened into a planar shape.

4. The heat medium eating device according to claim 1, wherein
the inlet header parts and the outlet header parts of the plurality of flat heat exchange tubes are provided with communication holes that are communicated with each other when the flat heat exchange tubes are stacked, and
a portion around each of the communication holes is sealed by a seal member that is brought into close contact therewith by the pressing of the heat exchange holding member.

5. The heat medium heating device according to claim 1, further comprising a control substrate that is integrally placed on a surface of the heat exchange holding member with an intermediation of an electrically insulating sheet, the control substrate having, a surface on which a control circuit is mounted, the control circuit including a heat generating electrical component that controls current application to the PTC heaters.

6. The heat medium heating device according to claim 5, wherein
the heat generating electrical component mounted on the control substrate is coolable through a heat transfer part provided to the control substrate and the electrically insulating sheet that is thermally conductive, with the heat exchange holding member made of an aluminum-alloy plate serving as a heat sink.

7. A vehicular air-conditioning device comprising:
a heat radiator disposed in an airflow path; and
a heat medium heating device that heats a heat medium, the heated heat medium being circulatable in the heat radiator, wherein
the heat medium heating device is the heat medium heating device according to claim 1.
